(19) United States
(12) Patent Application Publication
(10) Pub. No.: US 2011/0207829 A1
(43) Pub. Date: Aug. 25, 2011

(54) CONTROL OF TERMITES, FIRE ANTS AND CARPENTER ANTS

(75) Inventors: Robert H. Bedoukian, West Redding, CT (US); Ashok Raina, Ellicott city, MD (US)

(73) Assignee: Bedoukian Research, Inc

(21) Appl. No.: 12/998,514

(22) PCT Filed: Nov. 2, 2009
(86) PCT No.: PCT/US09/05928

§ 371 Date: Apr. 28, 2011

Related U.S. Application Data
(60) Provisional application No. 61/198,091, filed on Nov. 3, 2008.

(51) Int. Cl. A01N 31/02; A01N 35/06; A01N 31/04; A01P 7/04

(52) U.S. Cl. 514/690; 514/739; 514/730; 514/724

(57) ABSTRACT

Carvone, linalool, styralyl alcohol and tetrahydrolinalool are effective for the control of termites, fire ants and carpenter ants.

### FIELD OF THE INVENTION

The invention relates to improved pesticidal chemicals and pesticidal compositions of naturally occurring compounds and methods of using same for control of the Formosan and other subterranean termites, imported fire ants and carpenter ants, particularly employing such compositions of naturally occurring compounds and methods to control termites, fire ants and carpenter ants with pesticidal compositions effective by both vapor transmission and also effective against termites when they are found in soil and/or wood environments.

### BACKGROUND OF THE INVENTION

Subterranean termites in general and the Formosan subterranean termite (FST) in particular are a very serious urban pest not only in the United States but also in many countries throughout the world. In the United States, in addition to the native subterranean termites, several southern states and Hawaii are infested with the exotic FST, Coptotermes formosanus Shiraki (Isoptera: Rhinotermitidae). In addition to infecting wooden structures the FST also infects live trees. Established colonies of foraging subterranean termites, for example Reticulitermes spp and C. formosanus, are difficult to eradicate. These termites are known to cause colossal destruction of human property resulting in great economic loss. These termites are known to cause over two billion dollars in preventive control, damage and repair costs each year.

The subterranean habitat of such termites makes it very difficult to treat infestation sites with conventional insecticides. It has become increasingly apparent that widespread use of synthetic chemical pesticides has caused detrimental environmental effects that are harmful to humans. Residual pesticides have been found in food, ground water and throughout the environment. Many of these pesticides are toxic or carcinogenic or are otherwise detrimental to humans and animals as well as fish. The inventory of conventional insecticides is greatly reduced because of stricter restrictions and regulatory guidelines based on environmental concerns and safety measures. Currently, baits containing chitin synthesis inhibitors (which disrupt molting), is the main tool used for termite control. In spite of being effective, it has two drawbacks; the termites have to first find the bait and additionally the process of colony elimination may take anywhere up to three months. The latter projection is based on the fact that only about 1% of the termite workers in a colony molts each day.

The previously referred to regulatory guidelines have encouraged a search for potentially less dangerous pesticides by restricting the use of certain synthetic pesticides or elimination of certain effective pesticides from the marketplace and reduced the ability to control pests. Therefore, natural products have become of possible interest because they are generally safer to humans and the environment than synthetic pesticides. Some natural products, particularly those that are volatile, have been studied for termite control (Wilkins, Mater. Org. 27: 47-65 (1992); Bläske and Hertel, J. Econ. Entomol. 94: 1200-1208 (2001); Tellez et al., Sociobiology 41: 153-167 (2003); Park and Shin. J. Agric. Food Chem. 53: 4388-4392 (2005); Raina et al., J. Econ. Entomol. 100: 880-885 (2007). Cornelius et al., J. Econ. Entomol. 90: 320-325 (1997) determined the toxicity of monoterpenoids and other natural products to C. formosanus in test tubes containing sand treated with these compounds. However, in most cases tests were carried out in Petri dishes, which do not take into account the cryptic nature of subterranean termites. Many a time very high doses have been used to demonstrate efficacy of a chemical. As example, Bessette U.S. Pat. No. 6,858,653 claims that about 25 mg (example 1) of several plant essential oils, applied to glass Petri dishes, killed 100% of drywood termites in 1 hr. It is also to be noted that these tests involved potential physical contact with the test substances, and were performed in an environment that does not simulate the natural soil and wood environment of the FST. Whereas, some of the plant essential oil components, such as carveol, citronellal, p-cymene and geraniol, were claimed to cause high mortality of drywood and other termites in Petri dish assays, we found them to be totally ineffective against termites in soil and wood.

Current termite management practices include the use of baits placed around properties to be protected. A major drawback of the baits is that termites have to first find these baits and the treatments are costly and often time consuming. Thus, because of the problem termites present, there is increasingly greater interest in controlling these termites.

In the southern United States, fire ants, Solenopsis invicta, are a significant pest. For example, foraging fire ants are known to destroy young citrus trees, growing crops, and germinating seeds. Fire ants are omnivorous, feeding on almost any plant or animal matter and they damage young plants by gnawing holes in roots, tubers, stalks, and buds. The fire ant population has increased so rapidly that they are responsible for the major destruction of crops such as soybeans, potatoes and other vegetables in the farming regions of the United States where they have taken over. They have had a major impact on ground nesting animals and they are a menace to both humans and domestic animals alike. Their venom can cause health problems for humans who are hypersensitive to their venom. For a great number of years there has been a need to control the spread of black and red imported fire ants that are invading ever-increasing areas of the United States. With each passing year they spread further north, east and west affecting more states and causing hundreds of million dollars worth of damage per year.

One approach to control fire ants has been to employ synthetic chemical pesticides, but these have met very limited success. Moreover, these synthetic chemical pesticides can also pose grave environmental hazards. Federal agencies of the US government have imposed restrictions on some chemicals in an effort to protect the environment from the harmful toxic effects produced by these chemicals. Among the chemicals banned or restricted in use by governments are: DDT, Chlorodane, Lindane, Aldrin, Heptechlor, Dieldrin, and Mirex. Mirex (perchloropentacyclodecane) was found to be one of the most effective fire ant killers, however since its use has been banned in the United States because it has been found to be a, bioaccumulative, and toxic pollutant, the fire ant population has increased rapidly.

There are still a number of commercial pesticide products on the market currently. These pesticides are typically contact poisons and are effective in killing a wide variety of insects. One which specifically targeted fire ants is the AMDRO® a hydramethylnon-based hydrazone insecticide product (trademark of Central Garden & Pet Company Corporation). This product is a delayed-action pesticide advertised to be effective against fire ants because it is eventually ingested by the queen. When the queen is killed, the colony vanishes and the mound is destroyed. However, AMDRO has a number of drawbacks. AMDRO loses much of it's effectiveness following contact with moisture. This is a serious shortcoming, since much of the domain of imported fire ants is along the southern coastal states of the United States, where rainfall is plentiful. AMDRO also has a short shelf life after the container has been opened.

Fire ants have a significant economic impact on agriculture in infested areas. Additionally, telecommunication companies spend substantial amounts of money each year on treating their electrical equipment to prevent fire ant invasion because fire ants are attracted to electrical fields and can short out electrical equipment. Moreover, farm equipment can be damaged by large fire ant mounds. Fire ants also present a problem to wildlife, such as with ground nesting birds and animals. Furthermore, fire ants are known to excavate the soil from under roadways causing damage.

Fire ants also pose a health care problem to the millions of people that are stung by them. Since a significant number of these people require medical care. Additionally it has been reported that fire ant stings are also blamed for several human deaths each year. Thus, because of the problem fire ants present there is increasingly greater interest in controlling these fife-ants.

This interest has resulted in much research and resources being expended through the years to develop compositions and methods for controlling fire ants. One type of desirable composition which would be of great interest would be a non-toxic naturally occurring reagent which could repel, or keep ants from invading a particular area or object.

Current methods for controlling structural infestations of carpenter ants include sanitation of potential and current nest sites, minimizing access to structures (e.g., preventing the contact of tree branches with a structure), and the application of insecticides to repel (perimeter spray barriers) and/or eliminate carpenter ants. The use of boric acid dust in dry, wall voids is reported to be effective for up to 20 years (Hansen and Akre, supra).

Recommendations for the chemical control of established structural infestations in the home are often accompanied with warnings of possible hazards to the applicator as well as children and pets. Alternative control methods such as effective biological control agents have not been found (Akre, R. D., L. D. Hansen, A. L. Antonelli [1989] Ext. Bull. Washington State Univ. Coop. Ext. Serv. 1989 rev. no. EB 0818, 6 pp.). A need clearly exists for a safe, effective biological control agent for carpenter ants.

One aspect of the present invention is to provide significantly effective compositions or formulations of naturally occurring compounds, particularly effective at significantly low concentrations, and chemicals there for that are able to control and kill termites not only by vapors that can be carried by air to a target site to control or kill the termites but that can effectively penetrate wood and soil environments where the termites are found so as to control and kill them within that environment. Another aspect of this invention is to provide significantly effective compositions or formulations of naturally occurring compounds, particularly effective at significantly low concentrations, and chemicals there for that are able to control and kill fire and carpenter ants not only by vapors that can be carried by air to a target site to control or kill the fire ants but that can effectively penetrate soil environments where the fire ants are found so as to control and kill them within that environment. A further aspect of the invention is to provide significantly effective compositions or formulations of naturally occurring compounds, particularly effective at significantly low concentrations, and chemicals there 0.0 for that are able to control and kill both termites and fire and carpenter ants. Yet another aspect of this invention is to provide such significantly effective compositions or formulations of naturally occurring food grade compounds, particularly effective at significantly low concentrations that are both effective against fire and carpenter ants and termites and at the same time is generally non-toxic to humans, biodegradable and considered to be environmentally safe.

### SUMMARY OF THE INVENTION

In one aspect of the invention, control of termites has been achieved with the use of compositions or formulations containing at least one of the naturally occurring compounds d- or l-linalool, d- or l-carvone, styralyl alcohol, and tetrahydrolinalool. The use of the compounds d- or l-linalool, d- or l-carvone, styralyl alcohol (alpha-methyl benzyl alcohol) and tetrahydrolinalool to control termites, fire ants and carpenter ants has been found to be effective by solution contact with the pests and by contact of the pests with vapor of these compounds. Vapors of these compounds have been found to be fully effective against fire ants and somewhat less effective against termites in their natural environments. These compounds have been found to produce generally at least about 50% mortality within 24 hours, and particularly about 100% mortality within 24 hours of the termites encountering these compounds in some of the aforementioned environments. For example, a termite mortality of at least about 50% or more, preferably 75% or more and up to and including 100% can be obtained with these compounds under varying use conditions. Any pesticidally effective amount of one or more of these compounds may be employed in control of the termites. The effective control compounds of this invention may also be employed with other know pesticides where desirable. A further aspect of this invention is to a method for control of termites that involves the application of compositions or formulations at least one of compounds d- or l-linalool, d- or l-carvone, styralyl alcohol (alpha-methyl benzyl alcohol) and tetrahydrolinalool to an environment where these termite pests are likely to be found, including soil and wooded environments. Mixtures of the enantiomers may also be employed. When used in this application the term “linalool” is inclusive of d-linalool, l-linalool and any mixtures thereof; and the term “carvone” is inclusive of d-carvone, l-carvone and ant mixtures thereof, unless indicated otherwise..

### DETAILED DESCRIPTION OF THE INVENTION

Control of termites and fire ants and carpenter ants has been achieved with the use of compositions or formulations containing at least one of the naturally occurring compounds linalool, carvone and tetrahydrolinalool. The use of the compounds linalool, carvone styralyl alcohol and tetrahydrolinalool to control termites has been found to be effective by solution contact with the termite pests and by contact of the termite pests with vapor mist of these compounds. Vapors of these compounds have been found to be fully effective against fire ants and somewhat less effective against termites in their natural environments. For example, a termite mortality of at least about 50% or more, preferably 75% or more and up to and including 100% can be obtained with these compounds under varying use conditions. A termite mortality of at least about 75% or more and up to and including 100% can be obtained in 1 day is obtained when the termites were contacted with 1% of one of the compounds. Use of one of the compounds in a vapor at a rate of 0.5 mg per liter volume produced a termite mortality of 100% in one day, and at a rate of 0.25 mg per liter volume produced a termite mortality of at least about 70% and in some cases at least about 95% mortality in one or two days. In the vapor soil environment a termite mortality of greater than 50% in 2 day was obtained at a rate of 25 mg of the compound. Any effective amount of one or more of these compounds may be employed in control of the termites. The effective control compounds of this invention may also be employed with other know pesticides where desirable. Additionally, according to an embodiment of this invention a method for control of termites or fire ants and carpenter ants involves the application of compositions or formulations at least one of compounds linalool, carvone, styralyl alcohol (alpha-methyl s benzyl alcohol) and tetrahydrolinalool to an environment where these pests are likely to be found, including soil and wooded environments.

The compounds linalool, carvone, styralyl alcohol (alpha-methyl benzyl alcohol) and tetrahydrolinalool may be employed in any suitable concentration producing acceptable control of termites. Such control effective concentration can be, but is not limited to, a concentration amount of from about 20 to about 600 ppm, more preferably in a concentration of from about 50 to about 400 or ppm and even more preferably in a concentration of from about 75 to about 300 or ppm as limited by their vapor pressure at the ambient temperature. A particularly desirable concentration for l-carvone and linalool for contact mortality is about 1% and a particularly desirable concentration for carvone and linalool as a vapor mist is pesticide is a rate of about 0.5 mg/liter.

The compounds linalool, carvone, styralyl alcohol (alpha-methyl benzyl alcohol) and tetrahydrolinalool may be employed in any suitable vehicle or carrier, including, but not limited to carriers such as vegetable oil, propylene glycol, organic solvents, aqueous solutions or emulsions, absorbent material of any type, or dissolved in plastics, A further exemplary means of using the pesticidally effective linalool, carvone and tetrahydrolinalool is to introduce such compounds into the nest of the pests when the pests are located behind a barrier wall. For example, such a method may comprise the following exemplary, but not limiting method. Such exemplary method may comprise locating the nest of the pests, e.g., termites, that are behind a barrier wall, such as by infrared thermography, moisture measurements, microwaves, acoustical means or the like, then providing one or more small holes in the barrier wall adjacent the nest and into the nest such as by drilling or the like, and then introducing, such as by injecting, a pesticidally effective amount of the at least one of the toxicant compound selected from linalool, carvone and tetrahydrolinalool into the nest by way of the one or more holes. The toxicant compound may be introduced into the nest either as the toxicant compound per se, or in an absorbent material or plastic matrix or as a solution in a suitable carrier vehicle such as propylene glycol-water mixtures.

The following test methods and assays were employed that demonstrate the usefulness of carvone, linalool and tetrahydrolinalool for the control of termites and fire and carpenter ants.

Formosan subterranean termites were collected from bucket traps placed in City Park,

New Orleans, La. Altogether five colonies designated 1314, 1559, 1732, 1743 and 1756 were used in the tests. After collection, the termites (primarily workers and soldiers) were transferred to plastic boxes with moist spruce slats. The boxes were stored in an incubator maintained at 28° C., 65% RH, and constant darkness. Termites were used within one month of their collection.

Assay for Contact Toxicity. The assay was conducted in 55 by 15 mm plastic Petri dishes. Initially, 22 chemicals were tested at 1.0%. The test chemicals were dissolved in 95% ethanol and 100 μl of the solution applied to 4.25-cm-diameter filter papers (approximate wt. 100 mg) to obtain concentrations of 1.0, 0.5 and 0.1% w/w {relative to the filter paper}. After allowing the solvent to evaporate, the filter paper was moistened with 180 μl distilled water.

Twenty workers were released into each Petri dish and all the dishes with one treatment were placed in secondary containers (to prevent desiccation of termites). Each chemical was tested with 3 colonies and replicated 4 times. All the containers were kept at 28° C. and constant darkness. Mortality was recorded after 1, 3, 5 and 7 days.

Assay for Vapor Toxicity. This test was conducted in 960 ml (approximately 1 liter) wide-mouth clear Qorpak™ (All-Pak, Inc.) bottles with PTFE lined caps. A 60 mm diameter glass Petri dish with a moist filter paper and 50 termite workers was placed at the bottom of each bottle. The test chemical was applied to a 1 cm diameter filter paper and suspended with an insect pin from the cap-liner. Each chemical was initially tested at 1 mg then at 0.1 and 0.5 mg. Since 0.1 and 0.5 mg doses caused very low and 100% mortality respectively, the final test was carried out at 0.25 mg. Each chemical was tested with different termite colonies and replicated three times. The bottles were placed in the incubator. Mortality was recorded after 1, 2 and 3 days by quickly taking the glass Petri dish with the termites out of the bottle (with a pair of long forceps) and replacing it after removing the dead workers.

Vapor Toxicity Under Subterranean Conditions. This test was also conducted in the

Qorpak™ bottles. A 35 by 40 by 7 mm piece of moist spruce was placed at the bottom of the bottle and covered with 40 g fine-sifted black soil. One hundred workers were released into each bottle and allowed to tunnel under the soil and into the wood. After 3 days, a test chemical was applied to a filter paper and suspended from the cap-liner. The chemicals were tested at a rate of 25 mg. Mortality was recorded after 2 days. The test was conducted with termites from 3 colonies and replicated 3 times.

In the contact toxicity testing l-carvone killed 77% and l-linalool killed 100% of the termites in 1 day when employed at a rate of 1 mg/liter. Styralyl Alcohol killed 98% in 1 day when employed at a rate of 0.5 mg/liter.

In the vapor mist toxicity testing l-carvone and l-linalool each killed 100% of the termites in 1 day when employed at a concentration of 0.5 mg, l-carvone killed 95% of the termites in 3 days when employed at 0.25 mg, and l-linalool killed 70% of the termites in 3 days when employed at 0.25 mg. Styralyl Alcohol killed 100% of the termites in 2 days when employed at the rate of 0.25 mg/liter volume.

In the vapor toxicity under subterranean conditions testing at 25 mg l-carvone killed 57% of the termites in 2 days and 37% in one day; l-linalool killed 69% of the termites in 2 days and tetrahydrolinalool killed 53% of the termites in 2 days, and Styralyl Alcohol killed 11%.

One drop (approximately 25 to 30 mg) of test compound (l-linaloo , l-carvone, and Styralyl Alcohol,) was applied to a filter paper within sealed jars (16 oz glass jar, 3½ inch diameter, 3⅞ inch high with plastic lids) containing ten carpenter ants per replicate with there being five replicates. Five negative controls with no test compounds were also run. The l-linalool, l-carvone, and styralyl alcohol each provided 100% mortality to the carpenter ants within 24 hours while the control produced 6% mortality over the same 24 hour period.

While the invention has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

We claim:

1. A method for the control of pests selected from the group consisting of termites, fire ants and carpenter ants in an area comprising apply to an environment where it is desired to control at least one of such pests a pesticidally effective amount of at least one compound selected from -carvone, linalool, styralyl alcohol and tetrahydrolinalool.

2. A method according to claim 1 wherein the compound is l-carvone.

3. A method according to claim 1 wherein the compound is l-linalool.

4. A method according to claim 1 wherein the compound is tetrahydrolinalool.

5. A method according to claim 1 wherein the compound is styralyl alcohol.

6. The method according to claim 1 wherein the pests to be controlled are termites.

7. A method according to claim 1 wherein the pests to be controlled are Formosan subterranean termites.

8. A method according to claim I wherein the compound is employed in an area that comprises an area selected from wood, soil and mixtures of wood and soil.

9. A method according to claim 6 wherein the compound is employed in an area that comprises an area selected from wood, soil and mixtures of wood and soil

10. A method according to claim 6 where application of the at least one compound results in at least about 50% mortality in about 2 days of the termites desired to be controlled.

11. A method according to claim 6 where application of the at least one compound results in up to 100% mortality in about 1 day of the termites desired to be controlled.

12. A method according to claim 1 wherein the pests to be controlled are fire ants and the compound applied is d-linalool.

13. A composition for control of pests selected from the group consisting of termites, fire ants and carpenter ants, said composition comprising a carrier vehicle and at least one compound selected from carvone, linalool, styralyl alcohol and tetrahydrolinalool present in the composition in an amount to be released therefrom in a pesticidally effective amount.

14. A composition according to claim 13 wherein at least one compound comprises linalool.

15. A composition according to claim 13 wherein at least one compound comprises l-carvone.

16. A composition according to claim 13 wherein at least one compound comprises l-linalool.

17. A composition according to claim 13 wherein at least one compound comprises tetrahydrolinalool.

18. A composition according to claim 12 wherein at least one compound comprises styralyl alcohol.
